(19) United States
(12) Patent Application Publication
(10) Pub. No.: US 2007/0287785 A1
(43) Pub. Date: Dec. 13, 2007

(54) Polyurethane resin for heat-insulating sash

(76) Inventors: Takashi Ishida, Kawanisi-City (JP); Yukiko Arima, Ashiya-City (JP); Mitsuaki Ikebe, Suita-City (JP)

Correspondence Address: BAYER MATERIAL SCIENCE LLC, 100 BAYER ROAD, PITTSBURGH, PA, 15205, US

(21) Appl. No.: 11/811,821

(22) Filed: Jun. 12, 2007

(30) Foreign Application Priority Data
Jun. 13, 2006 (JP) 2006-163624

(51) Int. Cl. C08K 3/34

(52) U.S. Cl. 524/450; 524/589

(57) ABSTRACT

A polyurethane resin useful for the production of a heat-insulating sash with a coated aluminum frame in which displacement (void caused by peeling) caused by shrinkage and expansion due to hot-cold cycles does not occur so that rain water can not enter the heat-insulating sash. The linear expansion ratio of the polyurethane resin is decreased by including wollastonite in the polyurethane-forming resin.

### FIELD OF THE INVENTION

The present invention relates to a polyurethane resin for use in a heat-insulating sash which comprises an aluminum frame, preferably having a film coating applied by electrodeposition which has been adhesively treated, and a polyurethane resin containing wollastonite, which is preferably integrally shaped with the aluminum frame.

### BACKGROUND OF THE INVENTION

Conventionally known heat-insulating sashes are composed of aluminum frames with a coating applied by electrodeposition (“coated frame(s)” or “coated aluminum frame(s)”) and polyurethane resins as heat-insulating materials, which are integrally shaped.

However, peeling tends to occur between the coated frames and the polyurethane resins after the integral shaping, because of the poor adhesion between the coated aluminum frames and the polyurethane resins, and because of the self shrinkage of the shaped polyurethane resins.

To solve this problem, an organic solvent type primer or the like is applied to the coated surface of the coated aluminum frame to improve the adhesion of the polyurethane to the frame (See JP-A-10-60310); or the film coating is removed by a mechanical means or the film coating is not applied from the beginning so as to improve the adhesion to the aluminum frame (JP-A-10-96371).

However, the coated aluminum frame peels from the polyurethane resin to form a gap between the frame and the resin (this gap being hereinafter referred to as a “displacement”), when such a heat-insulating sash in which the adhesion has been improved by any of these methods is repeatedly exposed to a cold atmosphere or a high temperature atmosphere. This occurs because the coated aluminum frame and the polyurethane resin repeatedly shrink and expand due to their large difference in linear thermal expansion coefficient.

When such a heat-insulating sash is used as a window frame, rain drops penetrate through such a displacement of the heat-insulating sash, and thus, this heat-insulating sash is unsatisfactory for use as the window frame.

Under such a circumstance, there is a growing demand for a polyurethane resin which has the linear thermal expansion coefficient having a decreased difference from that of a coated aluminum frame.

### SUMMARY OF THE INVENTION

It is an object of the present invention to provide a polyurethane resin which has the linear thermal expansion coefficient that differs from that of a coated aluminum frame by a small amount.

It is also an object of the present invention to provide an improved heat-insulating sash obtained by integrally shaping the coated aluminum frame which has been adhesively treated and the polyurethane resin used as a heat-insulating material.

These and other objects which will be apparent to those skilled in the art are accomplished with the polyurethane-forming compositions described in detail below.

### DETAILED DESCRIPTION OF THE INVENTION

The present invention provides a polyurethane composition which is particularly suitable for use in a heat-insulating sash. This composition includes: (A) a base resin that includes a polyol component, a crosslinker, a catalyst, and if needed, a foam stabilizer, and (B) a hardener which includes an organic polyisocyanate compound, and (C) from about 3 to about 20 wt. %, based on total weight of the polyurethane composition, of wollastonite.

The present invention also provides a polyurethane resin which includes from about 3 to about 20% by weight of wollastonite for use in a heat-insulating sash, which is integrally shaped with a coated aluminum frame with a surface that has been treated to improve adhesion.

The linear thermal expansion coefficient of the polyurethane resin of the present invention makes it particularly suitable for use in a heat-insulating sash, because it is close to the linear thermal expansion coefficient of the coated aluminum frame. The difference between the linear thermal expansion coefficient of the coated aluminum frame and the polyurethane resin is therefore smaller than in currently available sashes. When a heat-insulating sash made with the polyurethane resin of the present invention is repeatedly exposed to a cold atmosphere or a high temperature atmosphere, excellent adhesion (strength against peeling) can be obtained between the polyurethane resin and the coated aluminum frame.

Therefore, no displacement occurs between the coated aluminum frame (or the electrodeposition coating film) and the urethane resin when the urethane resin of the present invention is used in a heat-insulating sash for a window frame.

The present invention also relates to the use of a polyurethane resin containing wollastonite (hereinafter referred to as “W-containing polyurethane resin”) in a heat-insulating sash.

Wollastonite to be used in the present invention may be a sintered material or it may be an unsintered material. The wollastonite may be an anhydride or it may contain at most 0.2% by weight of water. The wollastonite used may also be a mixture of some of these forms of wollastonite.

Natural wollastonite may be used as it is, or it may be ground and classified for use. Synthesized wollastonite also may be used.

Wollastonite contains at least 95% by weight, preferably at least 96% by weight, most preferably at least 98% by weight of calcium metasilicate (CaSiO₃) as a main component.

Preferred forms of wollastonite include those having an average fiber length of from about 20 to about 800 μm, preferably from about 50 to about 700 μm, more preferably from about 100 to about 650 μm, and preferably have an average particle diameter of from about 5 to about 40 μm.

The ratio of the average fiber length to the average particle diameter (i.e. aspect ratio) may be from 0.5 to 160, preferably from 1.2 to 140, more preferably from 2.5 to 130.

The wollastonite to be used in the present invention may optionally be surface-treated with a surface treatment agent such as a silane coupling agent and titanate type coupling agent, and each of these types of wollastonite may be used alone or in combination. Preferably, wollastonite is not surface-treated with a surface treatment agent in view of the cost because the surface treatment costs are high.

The amount of wollastonite contained in the polyurethane resin is preferably from about 3 to about 20% by weight, preferably from about 5 to about 15% by weight, based on the total weight of the base resin, the hardener and wollastonite (namely, the weight of the polyurethane resin). When the amount of wollastonite in the polyurethane resin is from 3 to 20% by weight, the linear thermal expansion coefficient of the W-containing polyurethane resin becomes close to that of the coated aluminum frame, so that the difference between their linear thermal expansion coefficients becomes smaller.

In order not to cause any displacement at the interface between the polyurethane resin and the coated aluminum frame, even when a heat-insulating sash is repeatedly exposed to a cold atmosphere or a high temperature atmosphere, it is preferable to use from about 3 to about 20% by weight of wollastonite having an aspect ratio of 0.5 to 160 in the polyurethane resin, thereby decreasing the linear thermal expansion coefficient of the W-containing polyurethane resin to at most 3.5 relative to the linear thermal expansion coefficient of the coated aluminum frame.

A heat-insulating sash does not show any displacement at the interface between the W-containing polyurethane resin and the coated aluminum frame, even when repeatedly exposed to a cold atmosphere or a high temperature atmosphere.

When the amount of wollastonite in the polyurethane resin is from about 3 to about 20% by weight, the viscosity of the base resin incorporating wollastonite (hereinafter referred to as “base resin W”) does not become too high, and thus, the workability of the resin is not impaired.

Additionally, the viscosity of a polyurethane resin stock solution (i.e. a mixture of the base resin W and the polyisocyanate) does not become too high so the flowability of that stock solution does not become lower. Filling of the stock solution into the hollow recessed portion of the aluminum frame is not therefore hindered.

The viscosity of the base resin W is preferably from about 1,000 to about 4,000 mPas/25° C., more preferably from about 1,500 to about 3,200 mPas/25° C.

When the amount of wollastonite in the polyurethane resin is from 3 to 20% by weight, the mixability (or dispersibility) of wollastonite in the base resin is not a problem, and thus, preferably, the mixability of the polyurethane resin stock solution (or the uniform dispersibility in the polyurethane resin) is also sufficient when the stock solution is reacted and cured with the polyisocyanate.

When the amount of wollastonite is less than 3% by weight, the effect of decreasing the linear thermal expansion coefficient of the W-containing polyurethane resin can not be expected. When the wollastonite content is greater than 20% by weight, the viscosity of the base resin W becomes higher, and thus, the mixability of the polyurethane resin stock solution becomes poor. Accordingly, it is hard to obtain a polyurethane resin having stable properties.

Generally, wollastonite is included in the base resin. The wollastonite is generally mixed into the base resin as follows: first, a crosslinker, a catalyst and a foam stabilizer are added to a polyol at a normal temperature, and wollastonite is then added with stirring in an amount such that the resulting polyurethane resin will have a required content of wollastonite, and the resulting mixture is stirred for 10 to 20 minutes.

After completion of the stirring, the resultant polyurethane stock solution is preferably degassed in vacuum (10 to 30 torr) for 30 to 90 minutes, i.e., air included in the solution while being stirred and air contained in the voids of wollastonite is removed. By this degassing for 30 to 90 minutes, foaming due to the expansion of air bubbles can be suppressed, while the polyurethane resin stock solution is filled into the hollow recessed portion of the coated aluminum frame and is reacted and cured therein.

Preferably, the polyurethane resin for use as a heat-insulating resin is excellent in various kinds of performance, such as heat-insulation and resin strength (or hardness). The polyurethane resin may be obtained by mixing two liquids, that is, the base resin and the polyisocyanate hardener, and then reacting and curing them at room temperature. The base resin is composed of a polyol component made up of one or more common polyether polyols, a crosslinker, a catalyst, and if needed, a foam stabilizer. The hardener is an organic polyisocyanate compound.

The polyol component may be a single polyether polyol or it may be a mixture of a polyether polyol with one or more other polyols, such as a polyester polyol. The amount of other polyol is preferably not larger than 50% by weight, more preferably, it may be in the range of from 40 to 0.5% by weight, based on the weight of the polyol component.

The polyether polyol included in the polyol component of the present invention is a polyether polyol having from 2 to 8 hydroxyl groups in the molecule and an average hydroxyl equivalent of from about 100 to about 5,000. The polyether polyol is preferably an adduct of an alkylene oxide such as an ethylene oxide and propylene oxide to a hydroxyl group-containing compound, an amino group- and hydroxyl group-containing compound or an amino group-containing compound, as an initiator. Examples of suitable hydroxyl group-containing initiator compounds include: ethylene glycol, propylene glycol, diethylene glycol, glycerine, trimethylolpropane, pentaerythritol, sorbitol and saccharose. Examples of suitable amino group- and hydroxyl group-containing initiator compounds include: diethanol amine and triethanol amine. Examples of suitable amino group-containing initiator compounds include: ethylene diamine, diethylene triamine and diaminotoluene.

Examples of organic polyisocyanates useful as the hardener for the polyurethanes of the present invention include: 4,4′-diphenylmethane diisocyanate (4,4′ MDI), 2,4′-diphenylmethane diisocyanate (2,4′ MDI), polymethylenepolyphenyl polyisocyanate (polymeric MDI or pMDI), and urethane- or carbodiimide-modified products thereof. Each of the above compounds may be used alone or in combination.

In view of the safety and sanitation of a working environment, the use of toluene diisocyanate is not preferred.

The initiator for the polyether polyol can also be used as the crosslinker. Alternatively, a polyether polyol having an average hydroxyl equivalent no greater than 100, which is an adduct of an alkylene oxide to the initiator, can also be used as the crosslinker. The amount of the crosslinker is preferably from 0.5 to 10 parts by weight, based on 100 parts by weight of the polyol component.

Amine catalysts and metal catalysts are among the catalysts useful in the practice of the present invention. Any of these catalysts may be used alone or in combination. Examples of suitable amine catalysts are tertiary amines such as triethylene diamine, pentamethyl diethylenetriamine, 1,8-diazabicyclo-5,4,0-undecene-7, dimethylaminoethanol, tetramethyl-ethylenediamine, dimethylbenzylamine, tetramethylhexamethylene diamine, bis(2-dimethylaminoethyl)ether, N,N′-dimethylaminopropyl amine, N,N′-dimethylethanol amine and 1-isobutyl-2-methylimidazole.

Examples of suitable metal catalysts include organotin compounds such as dibutyltin dilaurate, dibutyltin diacetate and tin octanoate, and alkali metal compounds such as potassium acetate.

The amount of catalyst used is preferably from about 0.01 to about 3 parts by weight, based on 100 parts by weight of the polyol component.

Examples of foam stabilizers which may be optionally added to the polyol component include silicone foam stabilizers. The foam stabilizer is used to stabilize and micronize the foams which are formed by the air involved at the mixing of two liquids, i.e. the base resin and the hardener. The amount of the foam stabilizer, if used, is preferably from about 0.01 to about 3 parts by weight, based on 100 parts by weight of the polyol component.

The base resin may contain other additives (e.g., a colorant, UV absorber and/or antioxidant). The amount of other additives is preferably no greater than 5 parts by weight, preferably, from 0.1 to 3 parts by weight, based on 100 parts by weight of the polyol component.

To mix the two liquids, i.e. the base resin and the hardener, so they will be reacted and cured at a room temperature, the amounts of the base resin and the hardener are selected so that the equivalent ratio of the isocyanate groups to the hydroxyl groups is preferably from 0.7 to 1.4, more preferably from 0.8 to 1.2 (NCO index).

It is preferred that no water be intentionally added to the base resin. The intrinsic water contents in the raw materials, e.g., the polyol, the crosslinker, the catalyst and the foam stabilizer, and water involved at the blending of these materials should preferably be no greater than 0.2% by weight, preferably, no greater than from 0.005 to 0.15% by weight, based on the weight of the base resin.

It is preferable that non-foamed polyurethane resin, i.e., a polyurethane formed from a reaction mixture to which no water was intentionally added to the base resin (to inhibit it from foaming), be used to produce heat insulating sashes in accordance with the present invention. Preferably, the density of the polyurethane resin is 1.0 g/cm³ (in view of the intrinsic water contained in the raw materials for the base resin and water involved in the mixing of them).

The use of the non-foamed polyurethane resin makes it easy to impart strength to the polyurethane resin which is to keep the shape of the coated aluminum frame, and thus is effective to prevent the deformation of the resultant heat-insulating sash.

Preferably, the reactivity of the two-liquid curing reaction type polyurethane resin (i.e. the base resin and the hardener) is controlled to be from 10 to 100 seconds, more preferably from 15 to 60 seconds, most preferably from 20 to 50 seconds in rise time. In this regard, the rise time means a period of time from the starting of the mixing of the base resin and the hardener at the liquid temperature of 25° C. to the point of time at which the mixture has been reacted and cured.

In the present invention, the polyurethane resin is adhered to the aluminum frame. Generally, the aluminum frame has a coating film formed on an aluminum substrate by electrodeposition. Examples of the coating film formed by electrodeposition include synthesized resin films, typically, an acrylic resin film or a fluororesin film. Preferably, the coating film is treated to improve adhesion.

In the adhesion treatment, a treating agent (i.e., a primer) is preferably applied to the surface of the coated aluminum frame. Preferably, the primer is prepared by dissolving a sulfonic acid compound as a main component in an organic solvent or water. In view of the working environment and VOC problems, it is preferable to use a water soluble sulfonic acid compound. An aqueous primer prepared by dissolving alkylbenzene sulfonic acid as a main component in water is particularly preferred.

The aqueous primer may be applied to the coated aluminum frame, using a brush, a spray or other known means, although any of the known application methods is suitable. Spraying is particularly preferred because the primer can be uniformly applied.

It is desirable to uniformly apply the aqueous primer in an amount as small as possible. The amount of the aqueous primer is preferably from about 1 to about 300 g/m², more preferably from about 10 to about 100 g/m².

There is no particular limit in selection of the temperature of the surface of the coated aluminum frame at the time of application of the aqueous primer. In view of the curing reaction of the polyurethane resin stock solution, the surface temperature of the aluminum frame is preferably from 5 to 40° C., more preferably, from 10 to 35° C. The range of 5 to 40° C. is advantageous because the curing reaction of the polyurethane-forming reaction mixture is not inhibited.

The applied aqueous primer may or may not be dried with air or the like.

The polyurethane-forming reaction mixture may be injected immediately after the application of the aqueous primer, preferably at least 5 minutes after the application of the primer.

The polyurethane resin containing 3 to 20% by weight of wollastonite is integrally shaped with the coated aluminum frame which has been treated as described above for improved adhesion. Thus, an integrally shaped product for a heat-insulating sash is obtained.

The high adhesion strength (or high strength against peeling) between the W-containing polyurethane resin and the coated aluminum frame which has been adhesion-treated can be maintained even when this heat-insulating sash is repeatedly exposed to a cold atmosphere or a high temperature atmosphere, so that no peeling or displacement occurs at the interface between the coated aluminum frame and the W-containing polyurethane resin. This heat-insulating sash is desirable as a window frame, because there is no displacement by which rain drops can penetrate.

### EXAMPLES

The present invention will be specifically described with reference to the examples below, but the present invention is not limited to the examples. Unless otherwise specified, “part” means “part by weight” and “%” means “% by weight.”

A molding of coated aluminum frame integrally molded with polyurethane resin containing wollastonite is hereinafter referred to as a “single-piece molding”.

Formulation of Raw Materials for Polyurethane Resin

The following raw materials were used in the indicated amounts to produce the polyurethane-forming reaction mixture used in these Examples:

(1) Base Resin:

(a) 100 parts by weight of polyoxypropylene triol (functionality=3, Molecular Weight=450) which is commercially available under the name Sumiphen™ from Sumika Bayer Urethane Co., Ltd
(b) 2.0 parts by weight of a dipropylene glycol solution containing 33% by weight triethylene diamine
(c) 0.1 parts by weight of dibutyltin dilaurate
   (2) Polyisocyanate Component
(a) Polymethylene polyphenyl polyisocyanate which is commercially available under the name Sumidur 44V20 from Sumika Bayer Urethane Co., Ltd

The Base Resin and the Polyisocyanate Component were blended at a weight ratio of Base Resin to Polyisocyanate Component of 102.1 to 71 parts by weight. The equivalent ratio of isocyanate groups/hydroxyl groups (NCO Index) was equal to 0.85.

The Base Resin and Polyisocyanate Components (at raw materials temperature of 25° C.) were hand mixed. The properties of the resultant polyurethane were as follows:
Rise time: 30 sec
Density: 1.05 g/cm³
Hardness (Shore-D) 65

The wollastonite used in these Examples had the following characteristics:

| Type | Wollastonite A | Wollastonite B |
|---|---|---|
| Content of calcium metasilicate (wt %) | 98.5 | 96.2 |
| Average fiber length (μm) | 600 | 100 |
| Average particle diameter (μm) | 40 | 5 |
| Aspect ratio | 15 | 20 |

Preparation Condition of Polyurethane Resin Containing Wollastonite for Measurement of Coefficient of Linear Thermal Expansion

The Base Resin containing wollastonite and the Polyisocyanate Component were adjusted to a temperature of 25° C., followed by mixing by hand mixing, and the resultant polyurethane-forming reaction mixture was poured into an aluminum profile (75×5×5 mm) coated with polytetrafluoroethylene adjusted to the temperature of 35° C. before introduction of the polyurethane-forming reaction mixture. 15 minutes after pouring the mixture into the profile, the hardened resin was demolded.

Preparation Condition of Single-Piece Molding

An aluminum window frame profile was coated with an acrylic resin by electrodeposition, and an aqueous primer was sprayed once on the aluminum window frame profile adjusted to 35° C. The aqueous primer was not dried and after 15 minutes, the polyurethane-forming reaction mixture produced by hand mixing the Base Resin containing wollastonite and the Polyisocyanate Component (each of which had been adjusted to a temperature of 25° C.), was poured into a hollow concave part of the aluminum window frame profile for reactive polymerization to produce a single-piece molding.

Measurement of Coefficient of Linear Thermal Expansion of Polyurethane Resin Containing Wollastonite

With the exception that a polyurethane resin size for measurement of 75×5×5 mm was used, the coefficient of linear thermal expansion was determined in accordance with JIS K-7197 (test method of coefficient of linear thermal expansion by thermal analysis using plastic).

The measurement was done in the lengthwise direction (L) of polyurethane resin, and an average of the measurement for each of 3 pieces was used as the coefficient of linear thermal expansion.

(1) Coefficient of Linear Thermal Expansion of Aluminum Member Coated by Electrodeposition

Since the thickness of the acrylic resin or fluororesin to be coated by electrodeposition was thin (several ten μm), it should have the same value as the coefficient of linear thermal expansion of raw aluminum.

(2) Coefficient of Linear Thermal Expansion of Raw Aluminum

2.37×10⁻⁵ mm/mm/° C.

(“Dictionary of physical and chemical research” edited by Iwanami Shoten; “Grand dictionary of chemistry” edited by Tokyo Kagaku Dozin Co., Ltd.; and Introduction to aluminum processing metallurgy edited by Light Metal Association)

Method for Evaluating Displacement in Single-Piece Molding

A heat-cold cycle test was conducted under the conditions described below and adhesion (shear peeling) strength after the heat-cold cycle test was measured. When the lowering ratio of the measurement to the initial adhesion strength is large, displacement was generated.

(1) Condition of Heat-Cold Cycle Test

One day after its production, a single-piece molding was placed in a drying oven at 80° C. for 4 hours, removed from the oven and immediately placed in a freezer at −20° C. for 4 hours. This heating and freezing was counted as one cycle. The molding was subjected to 30 cycles of such heating and freezing.

(2) Measurement of Adhesion Strength of Single-Piece Molding

One day after production, the initial adhesion strength of the single-piece molding was measured by an autograph in an atmosphere of 20° C., at a shear peeling speed (tensile speed) of 5 mm/min.

An adhesion strength of 700 N/cm or more is considered to be excellent.

The adhesion strength of the single-piece molding after being subjected to a heat-cold cycle test and allowed to stand at 20° C. for one day was measured in the same manner as the initial adhesion strength was measured.

(3) Evaluation Criterion of Generation of Displacement in a Single-Piece Molding

Good: No displacement (peeling) when the lowering ratio of adhesion strength is less than 15%
Bad: Some displacement (peeling) when the lowering ratio of adhesion strength is 15% or more.

### Example 1

10 parts by weight of Wollastonite A, based on 100 parts by weight of polyoxypropylene triol (5.5 wt % of Wollastonite A in polyurethane resin), were included in the Base Resin. The viscosity of wollastonite-containing Base Resin was 1500 mPas at 25° C. The compatibility with the Polyisocyanate Component was excellent, and the polyurethane-forming reaction mixture containing wollastonite for measurement of coefficient of linear thermal expansion and a single-piece molding were produced. There was no problem with pouring the polyurethane-forming reaction mixture into a hollow concave part of an aluminum profile with a surface coated by electrodeposition treated adhesively. The flowability was also excellent.

The linear expansion coefficient of the polyurethane resin containing wollastonite was 8.15×10⁻⁵ mm/mm/° C., i.e., 3.44 times the coefficient of linear thermal expansion of the aluminum profile coated by electrodeposition.

The lowering ratio of adhesion strength after heat-cold cycle test of the single-piece molding was 5.9%, which was determined to be no generation of displacement.

### Example 2

20 parts by weight of Wollastonite A, based on 100 parts by weight of polyoxypropylene triol (10.4 wt % of Wollastonite A in polyurethane resin) were included in the Base Resin. The viscosity of the wollastonite-containing Base Resin was 2500 mPas at 25° C. The compatibility with the Polyisocyanate Component was excellent. The polyurethane-forming reaction mixture containing wollastonite for measurement of coefficient of linear thermal expansion and a single-piece molding were produced. No problem was encountered with pouring the polyurethane-forming reaction mixture into a hollow concave part of an aluminum profile having the surface coated by electrodeposition treated adhesively. The flowability was also excellent.

The linear expansion coefficient of polyurethane resin containing wollastonite was 5.28×10⁻⁵ mm/mm/° C., i.e., 2.23 times the coefficient of linear thermal expansion of the aluminum profile coated by electrodeposition.

The lowering ratio of adhesion strength after the heat-cold cycle test of the single-piece molding was 1.3%, which was determined to be no generation of displacement.

### Example 3

30 parts by weight of Wollastonite A, based on 100 parts by weight of polyoxypropylene triol (14.8 wt % of Wollastonite A in polyurethane resin) were included in the Base Resin. The viscosity of the wollastonite-containing Base Resin was 3000 mPas at 25° C. The compatibility of the wollastonite-containing Base Resin with the Polyisocyanate Component was excellent. Polyurethane resin containing wollastonite for measurement of coefficient of linear thermal expansion and a single-piece molding were produced. No problem pouring the polyurethane-forming reaction mixture containing wollastonite into a hollow concave part of an aluminum profile having the surface coated by electrodeposition treated adhesively was encountered. The flowability was also excellent.

The linear expansion coefficient of polyurethane resin containing wollastonite was 3.94×10⁻⁵ mm/mm/° C., i.e., 1.66 times the coefficient of linear thermal expansion of the aluminum profile coated by electrodeposition.

The lowering ratio of adhesion strength after heat-cold cycle test of the single-piece molding was 10.1%, which was determined to be no generation of displacement.

### Example 4

10 parts by weight of Wollastonite B, based on 100 parts by weight of polyoxypropylene triol (5.5 wt % of Wollastonite B in polyurethane resin) was incorporated into the Base Resin. The viscosity of the wollastonite-containing Base Resin was 1600 mPas at 25° C. The compatibility of the wollastonite-containing Base Resin with the Polyisocyanate Component was excellent and the polyurethane resin containing wollastonite for measurement of coefficient of linear thermal expansion and a single-piece molding were produced from these components. No problem pouring the wollastonite-containing polyurethane reaction mixture into a hollow concave part of an aluminum profile with a surface coated by electrodeposition treated adhesively was encountered. The flowability was also excellent.

The linear expansion coefficient of polyurethane resin containing wollastonite was 6.91×10−5 mm/mm/° C., i.e., 2.92 times the coefficient of linear thermal expansion of the aluminum profile coated by electrodeposition.

The lowering ratio of adhesion strength after heat-cold cycle test of the single-piece molding was 5.0%, which was determined to be no generation of displacement.

### Example 5

20 parts by weight of Wollastonite B, based on 100 parts by weight of polyoxypropylene triol (10.4 wt % of Wollastonite B in polyurethane resin) were incorporated into the Base Resin. The viscosity of the wollastonite-containing Base Resin was 2600 mPas at 25° C. The compatibility of the wollastonite-containing Base Resin with the Polyisocyanate Component was excellent. A polyurethane resin containing wollastonite for measurement of coefficient of linear thermal expansion and a single-piece molding were produced. No problem pouring the wollastonite-containing polyurethane-forming reaction mixture into a hollow concave part of an aluminum profile with a surface coated by electrodeposition treated adhesively. The flowability was also excellent.

The linear expansion coefficient of polyurethane resin containing wollastonite was 5.42×10⁻⁵ mm/mm/° C., i.e., 2.29 times the coefficient of linear thermal expansion of the aluminum profile coated by electrodeposition.

The lowering ratio of adhesion strength after heat-cold cycle test of the single-piece molding was 3.3%, which was determined to be no generation of displacement and excellent.

### Example 6

30 parts by weight of Wollastonite B, based on 100 parts by weight of polyoxypropylene triol (14.8 wt % of Wollastonite B in polyurethane resin) were included in the Base Resin. The viscosity of the wollastonite-containing Base Resin was 3200 mPas at 25° C. The compatibility of the wollastonite-containing Base Resin with the Polyisocyanate Component was excellent. A polyurethane resin containing wollastonite for measurement of coefficient of linear thermal expansion and a single-piece molding were produced. No problem pouring the wollastonite-containing polyurethane-forming reaction mixture into a hollow concave part of an aluminum profile with a surface coated by electrodeposition treated adhesively. The flowability was also excellent.

The linear expansion coefficient of polyurethane resin containing wollastonite was 4.35×10⁻⁵ mm/mm/° C., i.e., 1.84 times the coefficient of linear thermal expansion of the aluminum profile coated by electrodeposition.

The lowering ratio of adhesion strength after heat-cold cycle test of the single-piece molding was 9.9%, which was determined to be no generation of displacement and excellent.

### Comparative Example 1

Polyurethane resin containing no wollastonite was produced for measurement of linear expansion coefficient and a single-piece molding was produced. The viscosity of the Base Resin was 1400 mPas at 25° C. The coefficient of linear thermal expansion of the polyurethane resin was 8.55×10⁻⁵ nm/mm/° C., i.e., 3.61 times the coefficient of linear thermal expansion of the aluminum profile coated by electrodeposition. The lowering ratio of adhesion strength after heat-cold cycle test of the single-piece molding was large and poor as 35.1%, which was estimated to be some generation of displacement.

### Comparative Example 2

3 parts by weight of Wollastonite A, based on 100 parts by weight of polyoxypropylene triol (1.7 wt % of Wollastonite A in polyurethane resin) were incorporated into the Base Resin. The viscosity of the wollastonite-containing Base Resin was 1400 mPas at 25° C. The compatibility of the wollastonite-containing Base Resin with the Polyisocyanate Component was not bad. A polyurethane resin containing wollastonite for measurement of coefficient of linear thermal expansion and a single-piece molding were produced. The coefficient of linear thermal expansion of polyurethane resin containing wollastonite was 8.50×10⁻⁵ mm/mm/° C., i.e., 3.59 times the coefficient of linear thermal expansion of the aluminum profile coated by electrodeposition.

No problem pouring the wollastonite-containing polyurethane-forming reaction mixture into a hollow concave part of an aluminum profile with a surface coated by electrodeposition treated adhesively. The flowability was also excellent.

The lowering ratio of adhesion strength after heat-cold cycle test of the single-piece molding was large and poor as 25.0%, which was determined to be some generation of displacement.

### Comparative Example 3

45 parts by weight of Wollastonite A, based on 100 parts by weight of polyoxypropylene triol (20.6 wt % of Wollastonite A in polyurethane resin) were included in the Base Resin. The viscosity of the wollastonite-containing Base Resin was 5200 mPas at 25° C. Because of the high viscosity of the Base Resin containing wollastonite, its compatibility with the Polyisocyanate Component was so bad that the surface of the polyurethane containing wollastonite was bad. It was difficult to pour the resin into a hollow concave part of an aluminum profile having the surface coated by electrodeposition treated adhesively, and the flowability in the hollow concave part was poor and bad even in the case of pouring.

### Comparative Example 4

3 parts by weight of Wollastonite B, based on 100 parts by weight of polyoxypropylene triol (Wollastonite B of 1.7 wt % in polyurethane resin) were included in the Base Resin. The viscosity of the wollastonite-containing Base Resin was 1400 mPas at 25° C. The compatibility of the wollastonite-containing Base Resin with the Polyisocyanate Component was not bad. A polyurethane resin containing wollastonite for measurement of coefficient of linear thermal expansion and a single-piece molding were prepared. The coefficient of linear thermal expansion of the polyurethane resin containing wollastonite was 8.31×10⁻⁵ mm/mm/° C., i.e., 3.51 times the coefficient of linear thermal expansion of the aluminum profile coated by electrodeposition.

No problems injecting the polyurethane-forming reaction mixture into a hollow concave part of an aluminum profile having a surface coated by electrodeposition treated adhesively. The lowering ratio of adhesion strength after heat-cold cycle test of the single-piece molding was large and poor as 27.2%, which was determined to be some generation of displacement.

### Comparative Example 5

45 parts by weight of Wollastonite B, based on 100 parts by weight of polyoxypropylene triol (20.6 wt % of Wollastonite B in polyurethane resin) were included in the Base Resin. The viscosity of the wollastonite-containing Base Resin was 5400 mPas at 25° C. Because of the high viscosity of the Base Resin containing wollastonite, its compatibility with the Polyisocyanate Component was so bad that the surface of polyurethane containing wollastonite was bad. It was difficult to pour the resin into a hollow concave part of an aluminum profile having a surface coated by electrodeposition and treated adhesively. The flowability in the hollow concave part was poor and bad even in the case of pouring.

TABLE 1

| | Example | | | | | |
|---|---|---|---|---|---|---|
| | 1 | 2 | 3 | 4 | 5 | 6 |
| Wollastonite A (parts by weight) | 10 | 20 | 30 | | | |
| Wollastonite B (parts by weight) | | | | 10 | 20 | 30 |
| Viscosity of wollastonite-containing Base Resin | 1500 | 2500 | 3000 | 1600 | 2600 | 3200 |
| (mPas at 25° C., B type viscometer) | | | | | | |
| Content of wollastonite in polyurethane resin (% by weight) | 5.5 | 10.4 | 14.8 | 5.5 | 10.4 | 14.8 |
| Compatibility with Polyisocyanate Component | Excellent | Excellent | Excellent | Excellent | Excellent | Excellent |
| Linear expansion coefficient of polyurethane resin containing | 8.15 | 5.28 | 3.94 | 6.91 | 5.42 | 4.35 |
| wollastonite (×10⁻⁵ mm/mm/° C.) | | | | | | |
| Ratio to the linear expansion coefficient of aluminum coated by | 3.44 | 2.23 | 1.66 | 2.92 | 2.29 | 1.84 |
| electrodeposition | | | | | | |
| Injection flowability into a hollow concave part of an aluminum | Excellent | Excellent | Excellent | Excellent | Excellent | Excellent |
| profile | | | | | | |
| Adhesion strength of single-piece molding (N/cm) | | | | | | |
| In initial stage (after one day from molding) | 837 | 976 | 781 | 820 | 953 | 778 |
| after hot-cold cycle test, | 788 | 963 | 702 | 779 | 922 | 701 |
| Lowering ratio (%) | 5.9 | 1.3 | 10.1 | 5.0 | 3.3 | 9.9 |
| Displacement (Good: None, Bad: Present) | Good | Good | Good | Good | Good | Good |

TABLE 2

| | Comparative example | | | | |
|---|---|---|---|---|---|
| | 1 | 2 | 3 | 4 | 5 |
| Wollastonite A (parts by weight) | | 3 | 45 | | |
| Wollastonite B (parts by weight) | | | | 3 | 45 |
| Viscosity of wollastonite-containing Base Resin | 1400 | 1400 | 5200 | 1400 | 5400 |
| (mPas at 25° C., B type viscometer) | | | | | |
| Content of wollastonite in polyurethane resin (% by weight) | 0 | 1.7 | 20.6 | 51.7 | 20.6 |
| Compatibility with Polyisocyanate Component | Excellent | Excellent | Bad | Excellent | Bad |
| Linear expansion coefficient of polyurethane resin containing wollastonite | 8.55 | 8.50 | | 8.31 | |
| (×10⁻⁵ mm/mm/° C.) | | | | | |
| Ratio to the linear expansion coefficient of aluminum coated by | 3.61 | 3.59 | | 3.51 | |
| electrodeposition | | | | | |
| Injection flowability into a hollow concave part of an aluminum profile | Excellent | Excellent | Bad | Excellent | Bad |
| Adhesion strength of single-piece molding (N/cm) | | | | | |
| In initial stage (after one day from molding) | 870 | 850 | | 843 | |
| after hot-cold cycle test, | 565 | 637 | | 614 | |
| Lowering ratio (%) | 35.1 | 25.0 | | 27.2 | |
| Displacement (Good: None, Bad: Present) | Bad | Bad | | Bad | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polyurethane composition suitable for use in a heat-insulating sash comprising:
(A) a base resin comprising;
(1) a polyol component,
(2) a crosslinker,
(3) a catalyst, and
(4) optionally, a foam stabilizer,
and
(B) a polyisocyanate component comprising an organic polyisocyanate, and
(C) from 3 to 20% by weight, based on the total weight of (A), (B), (C), of wollastonite.

2. The composition of claim 1 in which the wollastonite has an average fiber length of 20 to 800 μm and an average particle diameter of 5 to 40 μm.

3. A heat insulating sash comprising a polyurethane resin containing from 3 to 20% by weight of wollastonite which is molded integrally with an aluminum frame having a film coating that was formed by electrodeposition and which has been adhesively treated.

4. The heat insulating sash of claim 3 in which the polyurethane resin is a not a foam.
